(19) United States
(12) Patent Application Publication
(10) Pub. No.: US 2013/0343046 A1
(43) Pub. Date: Dec. 26, 2013

(54) LED Light Tube

(71) Applicant: Chang Ching Tsai, Orlando, FL (US)

(72) Inventor: Chang Ching Tsai, Orlando, FL (US)

(73) Assignee: Chang Ching Tsai, Orlando, FL (US)

(21) Appl. No.: 13/355,535

(22) Filed: Jun. 22, 2012

(51) Int. Cl. F21V 21/00; F21V 7/00; F21V 5/00

(52) U.S. Cl. 362/217.05; 362/217.02; 362/217.14

(57) ABSTRACT

A hallow light tube for LED lighting comprises an inner surface, an outer surface and at least one end surface. At least one LED is placed on at least one end surface to provide edge illumination. The rays emitting from edge LEDs are fed into the light tube along the longitudinal directions. The inner surface and the outer surface can be aligned in different ways to meet different lighting requirements. The inner, outer and end surfaces can be textured. The texture includes a smooth surface, a diffusive surface, a surface with micro structures, a surface with gratings, a surface with grooves, a random scattering surface, and a surface of photonics crystal.

### BACKGROUND

The description relates to LED light tubes.

In some examples, the replacement of fluoresce light tube with light source of LEDs mainly uses an array of LED chips lining up along the axial direction of the light tube. In order to reach the uniformity of lighting intensities, a diffusive transmission cover is placed on the light tube to produce smooth illumination. One of the drawbacks of such a design is that the diffusive cover will cause a significant back reflection light inside the tube such that the power of transmission light is often less than 85% of the original illuminating power.

In the present invention, a design of light tube featuring side illumination with LEDs will, first simplify the light tube structure and, second improve the transmission efficiency to save more lighting power.

### SUMMARY

One object of this invention is to provide a LED light tube, wherein the light emitting from LEDs is diffracted and reflected through a hollow light tube into free space. The intensity distributions in the free space get smoothed and broadened by multiple diffractions and reflections inside the light tube.

In one aspect, a LED light tube includes a hollow tube and at least one LED. The hollow tube includes an inner surface, an outer surface, a first end surface and a second end surface. The inner surface encloses a hollow region. The outer surface encloses the inner surface coaxially along the longitudinal direction of the tube. The first end surface connects the inner and outer surfaces. The second end surface opposite to the first surface connects the inner and outer surfaces. The LED is placed on the first end surface of the light tube, wherein the LED emits light into a region between the inner and outer surfaces.

In one embodiment, the inner and outer surfaces of the light tube contain unsmooth surface structures.

In one embodiment, the first and second end surfaces of the light tube contain unsmooth surface structure.

In one embodiment, a radial distance between the inner and outer surfaces of the light tube is a spatial function along the axis of the light tube.

In one embodiment, the shapes of the inner and outer surfaces of the light tube are two surface functions along the axis of the light tube.

In one embodiment, at least one, LED is attached to the first end surface that connects the inner and outer surfaces of the light tube to provide edge illumination.

In another aspect, a LED light tube includes a hollow tube and at least one LED. The hollow tube includes an inner surface, an outer surface, and an end surface. The inner surface encloses a hollow region. The outer region encloses the inner surface coaxially along the longitudinal direction of the tube. The end surface connects the inner and outer surfaces. The LED is placed on the end surface of the light tube, wherein the LED emits light into a region between the inner and outer surfaces and, or into the hallow region enclosed by the inner surface.

In one embodiment, the inner surface is tapered along the longitudinal direction and the outer surface extends straightly along the longitudinal direction toward the end of the tube where the inner surface and outer surface intersect to form an inclination angle of the inner surface from the outer surface on a plane containing the axis.

Advantage of the present light tube is to provide omnidirectional illumination around an axis of a long tube with attached LEDs as side emitting light sources. The configuration of the light tube is simple and can be easily fabricated. Further objects and advantages of this invention will be apparent from the following detailed description with accompanied drawings.

### DESCRIPTION OF DRAWINGS

FIG. 1 is one example of light tube with one edge illumination.

FIG. 2 is the cross-section view of light tube in FIG. 1.

FIG. 3 illustrates the light propagation of the light tube in FIG. 1.

FIG. 4 is one example of light tube with two edge illuminations.

FIG. 5 is one example of non-parallel light tube.

FIG. 6 is one example of unsmooth inner and outer surfaces of a light tube.

FIG. 7 is one example of light tube with two edge illuminations.

FIG. 8 is one example of tapered light tube.

FIG. 9 is one example of light tube with one edge illumination.

FIG. 10 is another example of light tube with one edge illumination

### DETAILED DESCRIPTION

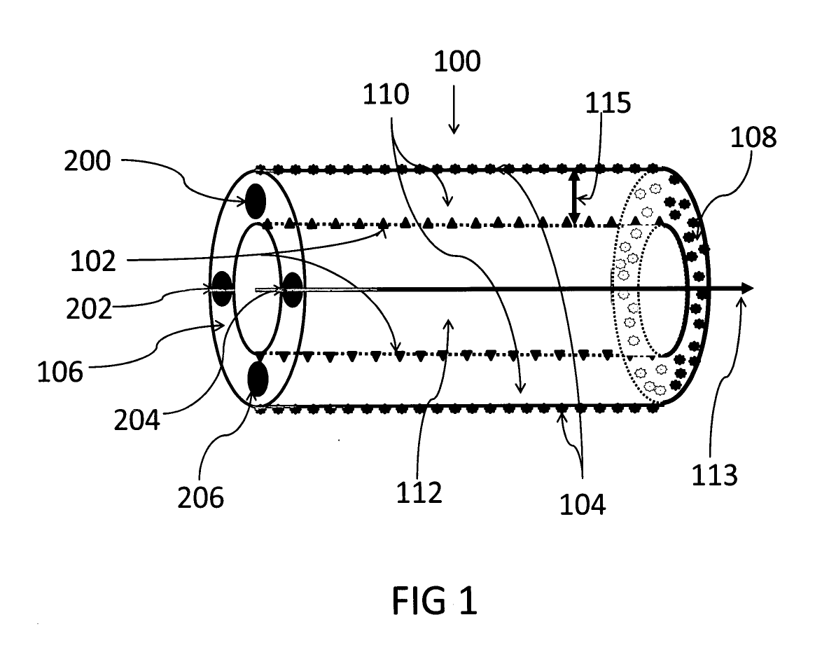

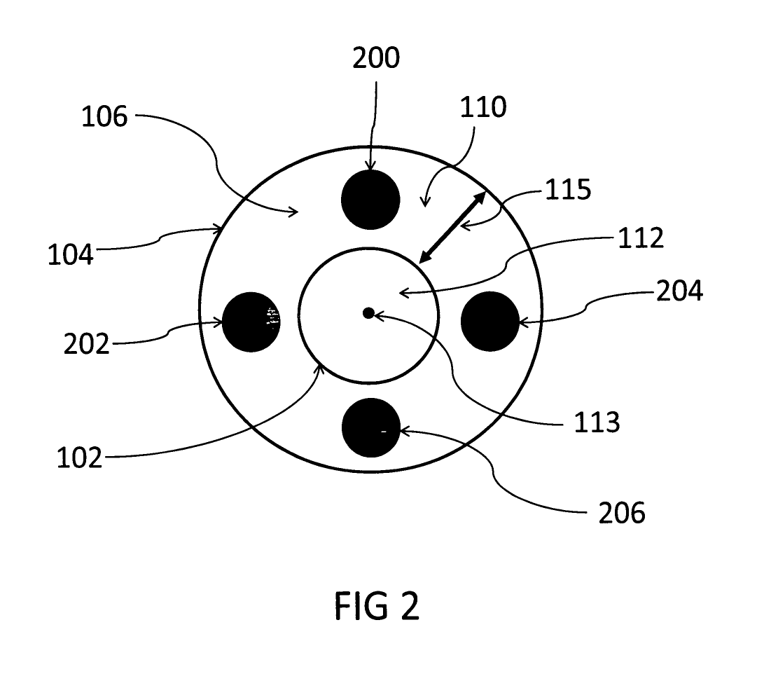

FIG. 1 shows one example of a hollow light tube 100 with one edge illumination. This light tube 100 has inner surface 102, outer surface 104, end surface 106 and end surface 108. The end surfaces 106 and 108 are bounded by the inner and outer surfaces 102 and 104. The inner and outer surfaces 102, 104 and two end surfaces 106, 108 enclose a cylindrical region 110. The inner surface 102 encloses a hollow region 112 with a light tube axis 113. A set of several LEDs 200, 202, 204, 206 are placed on the end surface 106 for one edge illumination. FIG. 2 shows the cross-sectional view of light tube 100, the end surface 106 bounded by the inner surface 102 and outer surface 104 for one edge illumination.

As shown in FIG. 1 and FIG. 2, a distance 115 between the inner surface 102 and the outer surface 104 measured radially from the axis 113, which can vary along the axial direction, is a spatial function selected from a group of geometric functions consisting of a straight line, a slant line, a curve, a parabola, a saw-like function, a sinusoidal function, a wave-like function, a repetitive triangular bump function, a repetitive round bump function, a repetitive square bump function, or any combination thereof. In this embodiment, the distance 115 is, including but not limited to, a constant spatial function along the axis 113.

The inner surface 102 may include a first shell of a material corresponding to a material of plastics, a glass, a metal, or a material with index of refraction greater than 1. Each of the outer surface 104 and the end surfaces 106 and 108 includes a second shell of a transparent material corresponding to a material of plastics, a glass, or a material with index of refraction greater than 1.

The bounded region 110 between the inner surface 102, the outer surface 104, the end surface 106 and the end surface 108 includes a transparent material corresponding to air, a glass, a plastics, a liquid, or a material with index of refraction greater than 1. The shape of the cross-section of the inner surface 102 is selected from a group consisting of a circle, an ellipse, a triangle, a square, a pentagon and a polygon. The shape of the cross-section of the outer surface 104 is selected from a group consisting of a circle, an ellipse, a triangle, a square, a pentagon and a polygon. Each of the inner surface 102, the outer surface 104, and the end surface 108 has a texture corresponding to a smooth structure, a diffusive structure, a grating structure, a grooving structure, a structure of random gratings, an irregular grooving structure, a random scattering structure, a photonics crystal structure, a periodic structure, a non-periodic structure, or any combination thereof. The end surface 106 may also have a texture corresponding to a smooth structure, a diffusive structure, a grating structure, a grooving structure, a structure of random gratings, an irregular grooving structure, a random scattering structure, a photonics crystal structure, a periodic structure, a non-periodic structure, a reflective structure, or any combination thereof.

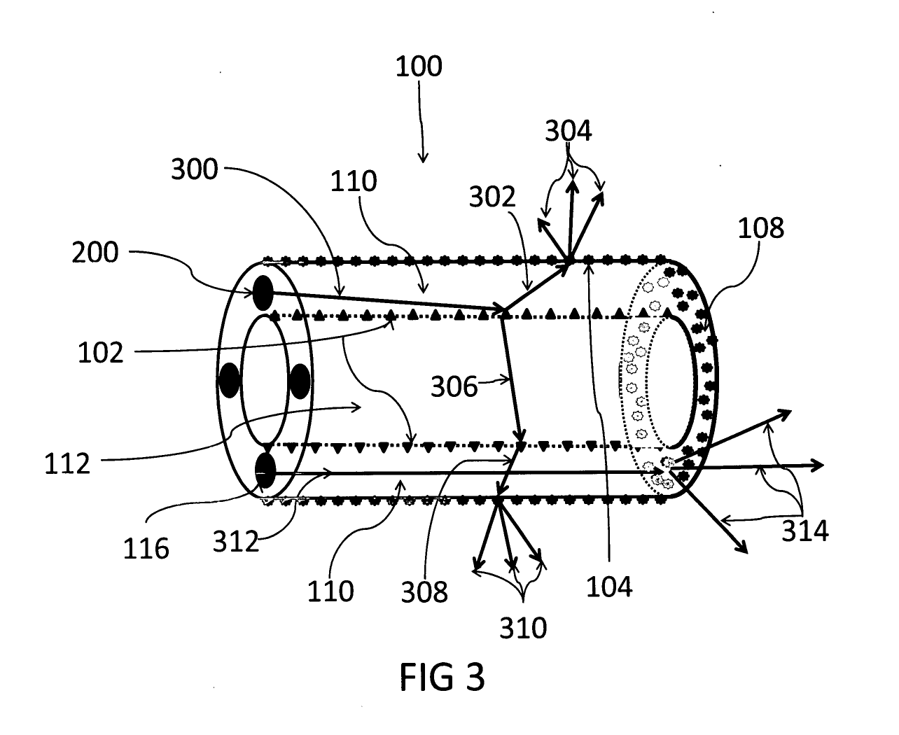

FIG. 3 illustrates the working principle of light tube 100. In this illustration, for example, the LED 200 emits ray 300 in the region 110 and subsequently hits the unsmooth inner surface 102. Part of the ray 300 becomes the reflected the ray 302 and part of the ray 300 becomes the transmitted the ray 306 in the region 112. The ray 302 propagates outward to the unsmooth outer surface 104 and transmits rays 304 into the air. The ray 306 propagates in the hollow region 112 to the unsmooth inner surface 102 and transmits the ray 308 in the region 110. The ray 308 propagates outward to the unsmooth outer surface 104 and transmits the rays 310 in the air. Because of the nature of the unsmooth surfaces 102 and 104, the ray 304 and 310 exhibit the property of diffusive light. Therefore, the outgoing rays 304 and 310 have wide and uniform distribution of light intensity in the air. On the other hand, ray 312 emitting from LED 116 hits the unsmooth end surface 108 and transmits the rays 314 into the air. The rays 314 possess the same property of diffusive light. The rays 304 and 310 here are considered as side illumination, as contributed from the side surface 104. The rays 314 here are considered as forward illumination, as contributed from the end surface 108 with attached LEDs 200, 202, 204, 206 shining in the forward direction.

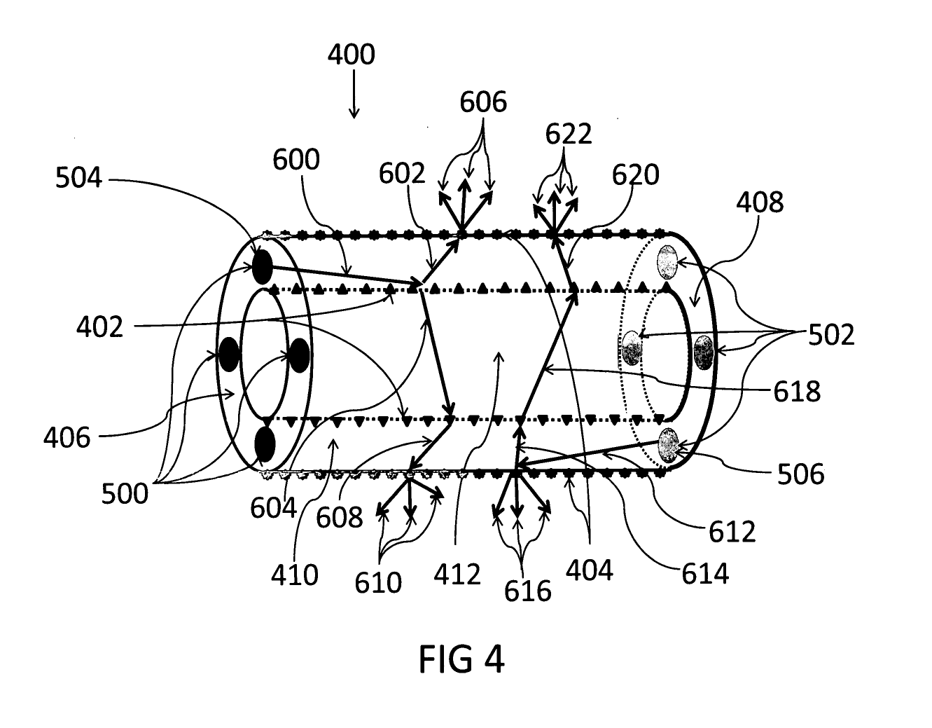

FIG. 4 shows one example of a hollow light tube 400 with two edges illumination. The inner surface 402, outer surface 404, end surface 406 and end surface 408 constitute the light tube 400. The inner surface 402 encloses a hallow region 412. This example of light tube 400 with two edge light sources, the set LEDs 500 placed on the end surface 406 and the set LEDs 502 placed on the end surface 408, provide the light tube 400 for side illumination in the free space. The working principle is similar to the light tube 100 except the part of forward illumination from the end surface 108. One example of the light propagation is that ray 600 emitting from LED 504 hits the inner surface 402, reflects the ray 602 outward and transmits the ray 604 inward. The ray 602 passes through the outer unsmooth surface 404 and becomes the rays 606 in the air. The ray 604 propagates inside the region 412, passes through the inner unsmooth surface 402 and becomes ray 608 in the region 410. The ray 608 then passes through outer unsmooth surface 404 and becomes the rays 610 in the air. In another example, the side illumination contributed from the LEDs set 502 placed on the end surface 408 follows the same manner. Ray 612 emitting from one LED 506, part of ray 612 becomes the reflected ray 614, and part of ray 612 becomes the transmitted rays 616 in the air. The ray 614 then subsequently becomes the transmitted rays 618, 620, finally 622 in the air. The rays 606, 610, 616 and 622 are the examples of the side illumination light emitting from the light tube 400.

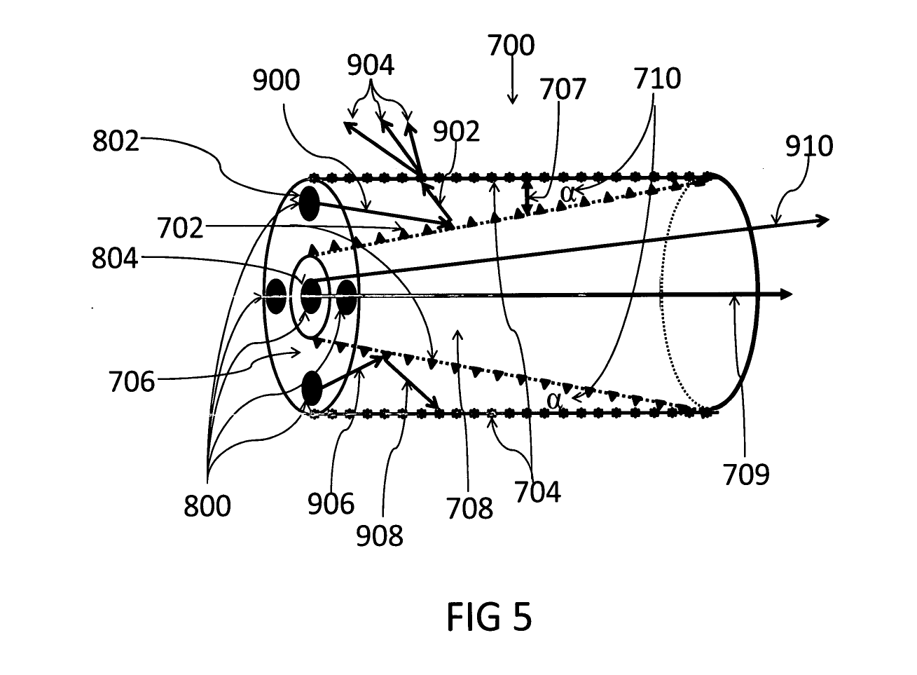

To have wide illumination distributed in certain free space, the inner and the outer surfaces of light tube can be designed in different configurations. One example is illustrated in FIG. 5. The light tube 700 has a tapered structure of inner surface 702 and a straight outer surface 704 along the longitudinal direction and one end surface 706 with a set of LEDs 800. The inner surface 702 and the end surface 706 enclose a hollow region 708 with an axis 709. The inclination angle a 710 of the inner surface 702 from the outer surface 704 on a plane containing the axis 709 is determined to enhance the backward illumination. That is, a distance 707 between the inner surface 702 and the outer surface 704 measured radially from the axis 709 of the light tube 700 is, including but not limited to, a linear function along the axis 709 of the light tube 700 in this example. As an illustration, the ray 900 emitting from the LED 802 hits the inner surface 702 and reflects the ray 902 backward to the outer surface 704. The backward ray 902 becomes the diffusive rays 904 in the air. In the design of light tube 700, the inclination angle a 710 will cause some light, like ray 906, to have total internal reflection such that the reflected ray 908 has identical intensity of ray 906 without loss to enhance the outward side illumination. The LED 804 is placed at the center of the end surface 706 to provide the complimentary illumination in the forward direction like the ray 910.

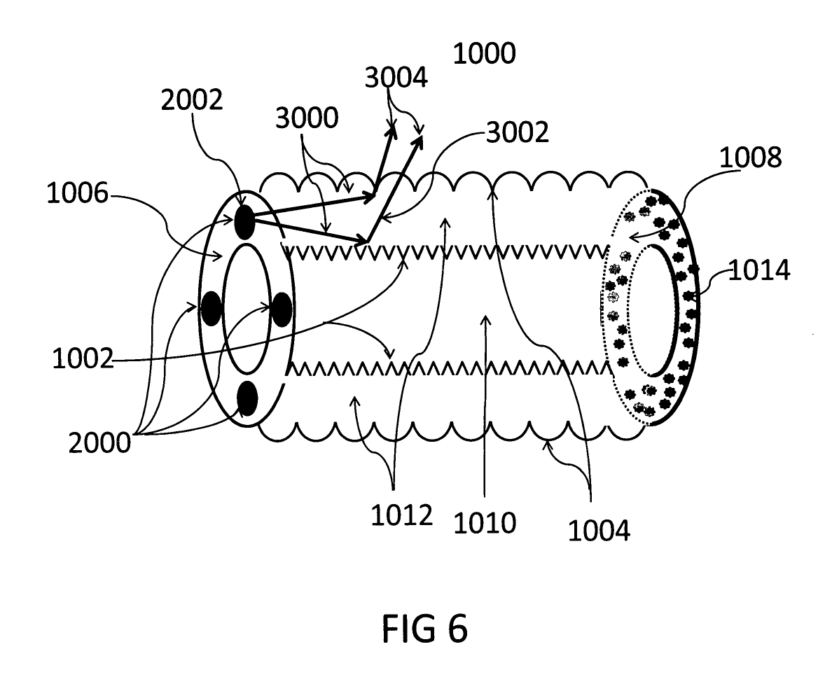

Unsmooth surface structure can reflect or transmit light with diffusive property because of diffraction or random propagation of light. This is one of the working principles of the present invention of light tube for wide illumination. FIG. 6 illustrates one example of unsmooth inner surface 1002 and outer surface 1004 of a light tube 1000 with one edge LEDs 2000 placed on one end surface 1006. A hollow region 1010 is enclosed by the inner surface 1002. The inner, outer and end surfaces 1002, 1004, 1006 and 1008 bound a region 1012. One end surface 1008 with uneven texture 1014 is for forward diffusive illumination. Ray 3000 emitting from the LED 2002 will mainly first propagate in the region 1012 between the inner surface 1002 and outer surface 1004. The saw-like inner surface 1002 will diffract ray 3000 in the region 1012 and becomes ray 3002 to have much more light scattered in the transverse direction to enhance side illumination. When part of ray 3000 and ray 3002 are diffracted to the outer surface of rings of micro-lens 1004, the outgoing rays 3004 will be diverged to wide region in the air.

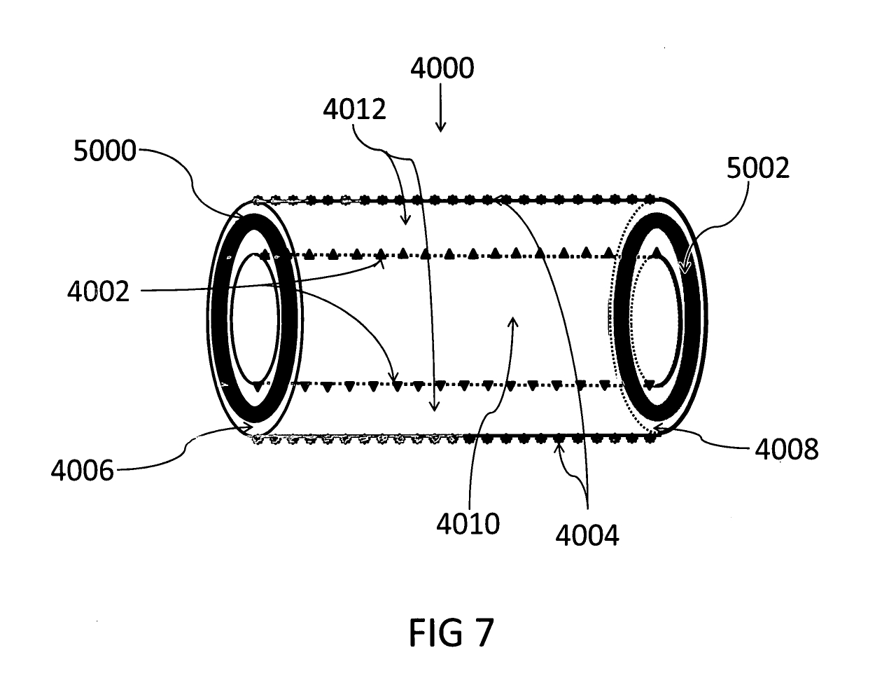

FIG. 7 shows an example of different configuration of LEDs 5000 and 5002 that are attached to a light tube 4000. Similar to the previous examples, there are inner surface 4002, outer surface 4004, two end surfaces 4006, 4008 constituting the light tube 4000. The inner surface 4002 encloses a hollow region 4010. Two rings of LEDs 5000 and 5002 are placed on the end surfaces 4006 and 4008 respectively for edge illuminations. The material in region 4012 bounded by the surfaces 4002, 4004, 4006 and 4008 can be chosen from a lot substances. For example, we can use plastics like PMMA or PC, or a liquid with the index of refraction greater than 1 to make the region 4012. In the easiest way, we can use plastic material PC to make the whole tube, i.e., the surfaces 4002, 4004, 4006, 4008 and the region 4012 are all made of PC.

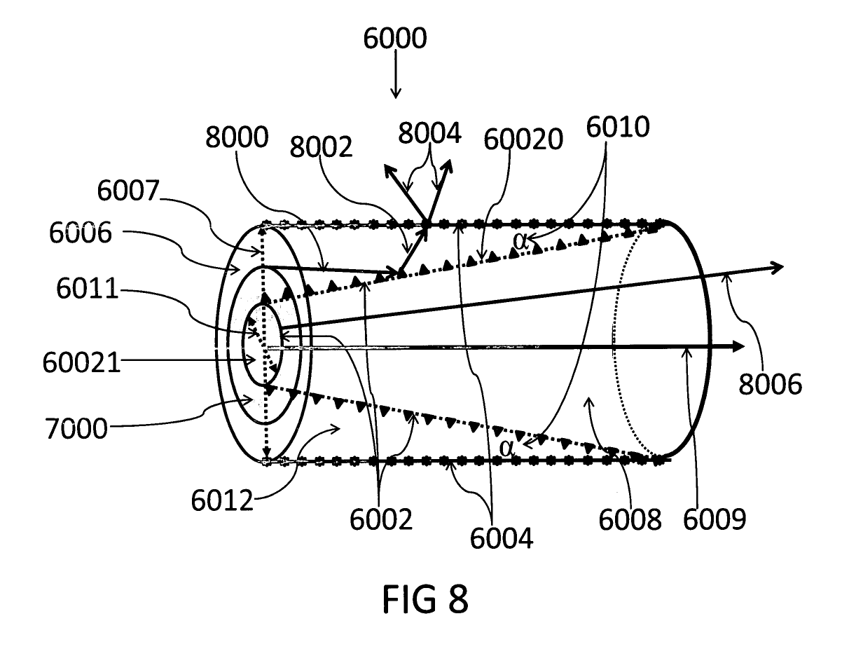

FIG. 8 shows another example similar to light tube 700 in the FIG. 5. In FIG. 8, light tube 6000 is constituted by inner surface 6002, outer surface 6004 and end surface 6006. End surface 6006 is a round area that has the same diameter 6007 of the outer surface 6004. The inner surface 6002 includes a cylindrical tapered structure 60021 and a bottom circular area 60022 of diameter 6011, together enclosing a hollow region 6008 with an axis 6009. The inner surface 6002 has a tapered structure 60021 with an inclination angle a 6010 from the outer surface 6004 on a plane containing an axis 6009. The substance in the region 6012 bounded by the inner surface 6002, outer surface 6004 and end surface 6006 is a material with the index of refraction greater than 1. A round LED chip 7000 is placed on the end surface 6006, which is larger than the bottom area 60022 of the inner surface 6002. Part of the ray 8000 emitting from LED 7000 hits the inner surface 6002 and becomes the reflected ray 8002 and later becomes the transmitted ray 8004 in the air to provide side illumination. Part of the ray 8006 emitting from LED 7000 propagates directly into the hollow region 6008 to provide forward illumination.

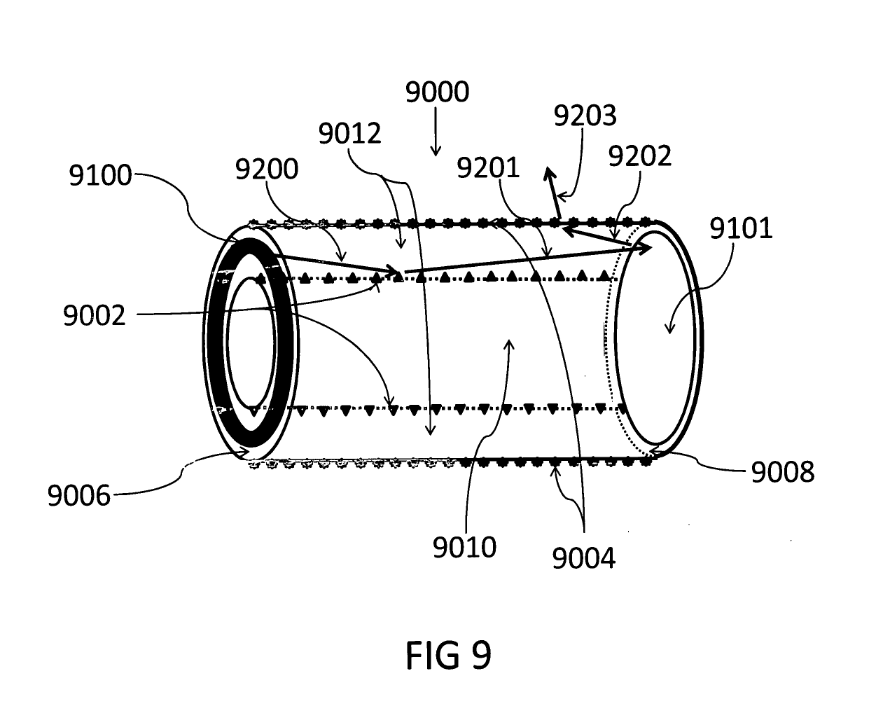

FIG. 9 shows another example of a light tube 9000. Similar to the example in FIG. 7, there are inner surface 9002, outer surface 9004, two end surfaces 9006, 9008 constituting the light tube 9000. One ring of LEDs 9100 and one reflector 9101 are placed on the end surfaces 9006 and 9008 respectively for edge illuminations. Ray 9200 emitting from ring LED 9100 incidents into region 9012 bounded by the surfaces 9002, 9004, 9006 and 9008. Ray 9200 hits the inner surface 9002 and becomes ray 9201. Ray 9201 hits reflector 9101 and reflects the ray 9202. Ray 9202 hits surface 9004 and becomes the transmitted ray 9203 in the air. This design of light tube 9000 with reflector 9101 consider to use only one high power LED ring 9100 to provide enough edge illumination instead of using two LED rings 5000 and 5002 as in FIG. 7, to simplify the light tube structure.

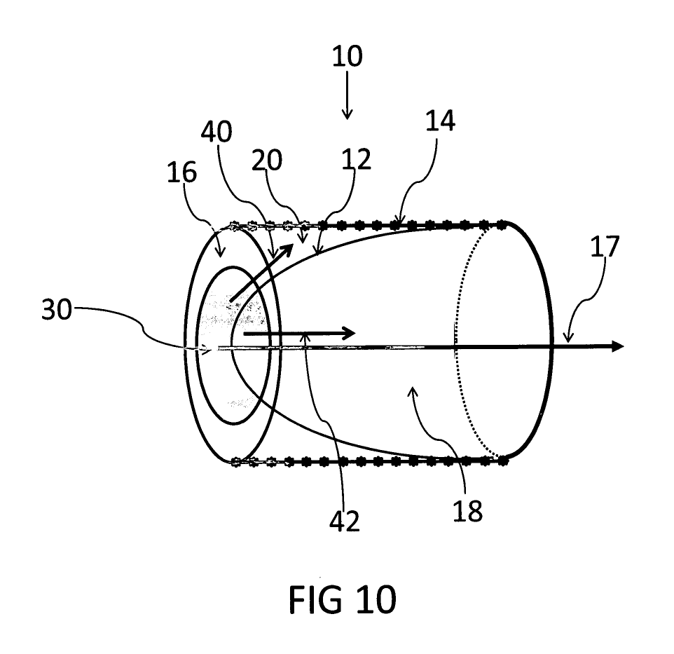

FIG. 10 shows another example of a light tube 10. An inner surface 12, an outer surface 14 and one end surface 16 constitute the light tube 10. The inner surface 12, outer surface 14 and end surface 16 bound a region 20, which is made of a transparent material with refractive index greater than 1. The inner surface 12 is a parabolic surface symmetric about a tube axis 17 and encloses a hollow region 18. A round LED chip 30 is placed on the end surface 16. Ray 40 emitting from LED 30 provides side illumination and Ray 42 emitting from LED 30 provides forward illumination. The design of light tube 10 illustrates another application in this invention, for example, that the light tube 10 can be used in the field of down lighting.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims.

What is claimed is:

1. A LED light tube comprising:
(a) a hollow tube comprising:
an inner surface enclosing a hollow region;
an outer surface enclosing the inner surface coaxially along a longitudinal direction of the tube;
a first end surface connecting the inner and the outer surfaces; and
a second end surface opposite to the first end surface, connecting the inner and the outer surfaces; and
(b) at least one LED placed on the first end surface of the light tube, wherein the LED emits light into a region between the inner and the outer surfaces.

2. The light tube of claim 1, wherein a distance between the inner surface and the outer surface, measured radially from an axis of the light tube, which can vary along the longitudinal direction is a spatial function selected from a group of geometric functions consisting of:
a straight line, a slant line, a curve, a parabola, part of a circle, part of an ellipse, a saw-like function, a sinusoidal function, a wave-like function, a repetitive triangular bump function, a repetitive round bump function, a repetitive square bump function, or any combination thereof.

3. The light tube of claim 1, wherein the inner surface comprises a first shell of a material corresponding to a plastic material, a glass, a metal, or a material with index of refraction greater than 1.

4. The light tube of claim 1, wherein each of the outer surface, the first end surface and the second end surface comprises a second shell of a transparent material corresponding to a plastic material, a glass, or a material with index of refraction greater than 1.

5. The light tube of claim 1, wherein a bounded region between the inner surface and the outer surface and the first and second end surfaces comprises a transparent material corresponding to air, a glass, a plastic material, a liquid, or a material with index of refraction greater than 1.

6. The light tube of claim 1, wherein a shape of a cross-section of each of the inner and outer surfaces is selected from a group consisting of:
a circle, an ellipse, a triangle, a square, a pentagon, and a polygon.

7. The light tube of claim 1, wherein each of the inner surface, the first end surface and the second end surface has a texture corresponding to: a smooth structure, a diffusive structure, a grating structure, a grooving structure, a structure of random gratings, an irregular grooving structure, a random scattering structure, a structure of photonics crystal, a periodic structure, a non-periodic structure, a structure of micro-lens, a reflective structure, or any combination thereof.

8. The light tube of claim 1, wherein the outer surface has a texture corresponding to:
a smooth structure, a diffusive structure, a grating structure, a grooving structure, a structure of random gratings, an irregular grooving structure, a random scattering structure, a structure of photonics crystal, a periodic structure, a non-periodic structure, a structure of micro-lens or any combination thereof.

9. The light tube of claim 1, further comprising at least one reflector attached on the second end surface.

10. The light tube of claim 1, further comprising another at least one LED placed on the second end surface of the light tube.

11. A LED light tube comprising:
(a) a hollow tube comprising:
an inner surface enclosing a hollow region;
an outer surface enclosing an inner surface coaxially along a longitudinal direction of the tube; and
an end surface connecting the inner and the outer surfaces; and
(b) at least one LED placed on the end surface of the light tube, wherein the LED emits light into a region between the inner and the outer surface and, or the hallow region enclosed by the inner surface.

12. The light tube of claim 11, wherein the inner surface is tapered along the longitudinal direction and the outer surface extends straightly along the longitudinal direction toward the end of the tube where the inner surface and outer surface intersect to form an inclination angle of the inner surface from the outer surface on a plane containing the axis.

13. The light tube of claim 11, wherein a distance between the inner surface and the outer surface, measured radially from an axis of the light tube, which can vary along the longitudinal direction is a spatial function selected from a group of geometric functions consisting of:
a straight line, a slant line, a curve, a parabola, part of a circle, part of an ellipse, a saw-like function, a sinusoidal function, a wave-like function, a repetitive triangular bump function, a repetitive round bump function, a repetitive square bump function, or any combination thereof.

14. The light tube of claim 11, wherein the inner surface comprises a shell of a material corresponding to a plastic material, a glass, a metal, or a material with index of refraction greater than 1.

15. The light tube of claim 11, wherein each of the outer surface and the end surface comprises a shell of a material corresponding to a plastic material, a glass, or a material with index of refraction greater than 1.

16. The light tube of claim 11, wherein a bounded region between the inner surface and the outer surface and the end surface comprises a transparent material corresponding to air, a glass, a plastic material, a liquid, or a material with index of refraction greater than 1.

17. The light tube of claim 11, wherein a shape of a cross-section of each of the inner and outer surfaces is selected from a group consisting of:
a circle, an ellipse, a triangle, a square, a pentagon, and a polygon.

18. The light tube of claim 11, wherein each of the inner surface and end surface has a texture corresponding to a smooth structure, a diffusive structure, a grating structure, a grooving structure, a structure of random gratings, an irregular grooving structure, a random scattering structure, a structure of photonics crystal, a periodic structure, a non-periodic structure, a structure of micro-lens, a reflective structure, or any combination thereof.

19. The light tube of claim 11, wherein the outer surface has a texture corresponding to a smooth structure, a diffusive structure, a grating structure, a grooving structure, a structure of random gratings, an irregular grooving structure, a random scattering structure, a structure of photonics crystal, a periodic structure, a non-periodic structure, a structure of micro-lens, or any combination thereof.

20. The light tube of claim 11, wherein the LED is a LED emits lights directly passing through the end surface into the region between the inner and the outer surface and, or into the hallow region enclosed by the inner surface.
